(19) United States
(12) Patent Application Publication
(10) Pub. No.: US 2016/0068017 A1
(43) Pub. Date: Mar. 10, 2016

(54) WHEEL LIFTING DEVICE

(71) Applicant: AB Kompositprodukter Vikmanshyttan, Vikmanshyttan (SE)

(72) Inventor: Mats Lindgren, Vikmanshyttan (SE)

(73) Assignee: AB Kompositprodukter Vikmanshyttan, Vikmanshyttan (SE)

(21) Appl. No.: 14/844,696

(22) Filed: Sep. 3, 2015

(30) Foreign Application Priority Data
Sep. 4, 2014 (SE) 1451035-8

(51) Int. Cl. B60B 29/00

(52) U.S. Cl. CPC B60B 29/002

(57) ABSTRACT

A wheel lifting device comprising a frame, a wheel support which is fixed to the frame and a manually manoeuvrable jack. The frame comprises guiding means which are arranged to receive at least two vertical bars of a two-wheeled tiltable hand cart and to guide the frame rectilinearly along said bars during vertical displacement of the frame relative to the handcart. The jack comprises an eccentric which is rotationally fixed to the frame or arranged to be rotationally fixed to the hand cart and which exhibits a peripheral support surface which is arranged to bear against hand cart or the frame respectively.

### CROSS-REFERENCE TO RELATED APPLICATIONS

This application claims the benefit of Swedish Patent Application No. 1451035-8, filed Sep. 4, 2014. The disclosure of the above application is incorporated herein by reference in its entirety.

### TECHNICAL FIELD

The invention concerns a device for lifting and positioning a wheel during wheel shifting on a vehicle, such as a car, a pick-up or the like.

### BACKGROUND

Shifting wheels of a vehicle, e.g. shifting from summer to winter wheels and vice versa, may be cumbersome and involves heavy lifting and manipulation of the wheels. Typically, each wheel to be mounted needs to be lifted between 30-100 mm above the ground and then manipulated and positioned such that the mounting holes of the rim are aligned with the wheel hub. Thereafter, the wheel needs to be maintained in position while fastening the mounting screws. Especially at larger vehicles such as pick-up trucks, SUVs, cross country trucks, general purpose vehicles, jeeps and the like, where the wheels often are comparatively large and heavy, such lifting and handling of the wheels involves awkward working positions, is tiresome and may even lead to injuries to the person involved.

### PRIOR ART

For this reason there have been suggested several devices intended to facilitate the lifting and positioning the wheels when carrying out wheel shifting. U.S. Pat. No. 4,050,597 A, US 2005/0254923 A1 and U.S. Pat. No. 3,850,321 A all disclose a previously known type of wheel lifting device comprising a first frame which is supported on wheels for moving and positioning the lifting device. A second frame which exhibits support means for the wheel to be lifted is arranged vertically movable relative to the first frame. A jack screw or a hydraulic or pneumatic jack is arranged between the first and second frame such that the second frame and the wheel to be lifted may easily be raised relative to the first frame and the ground. All these known lifting devices are comparatively complicated and comprise a large number of components. The devices are also comparatively large and require a great storage space when not in use. Additionally, these devices are entirely specifically designed for the purpose of lifting wheels and none of their constituent parts are intended or suitable to be used for any other purpose than lifting and positioning a wheel during wheel shifting at a vehicle.

### SUMMARY OF THE INVENTION

An object of the present invention is to provide an enhanced wheel lifting device to be used when shifting wheels of a vehicle.

Another object is to provide such a device which is simple in construction and which comprises a low number of constituent parts.

A further object is to provide such a device which may easily be mounted to already existing standardized hand carts, which hand carts may be used for other purposes when not used together with the wheel lifting device.

A still further object is to provide such a lifting device which is easy to use and reliable.

Yet another purpose is to provide such a lifting device which requires only a very limited storage space, when not in use.

A still further object is to provide such a device which may readily be produced in a cost efficient manner.

These and other purposes are achieved with a wheel lifting device specified in appended claim 1. The wheel lifting device comprises a frame, a wheel support which is fixed to the frame and a manually manoeuvrable jack. The frame comprises guiding means which are arranged to receive at least two vertical bars of a two-wheeled tiltable hand cart and to guide the frame rectilinearly along said bars during vertical displacement of the frame relative to the handcart. The jack comprises an eccentric which is rotationally fixed to the frame or arranged to be rotationally fixed to the hand cart and which exhibits a peripheral support surface which is arranged bear against the hand cart or the frame respectively.

The wheel lifting device may thus be attached to and used with a conventional standardized hand cart, of the type comprising two wheels, two manoeuvring handles and a load supporting surface. An example of such a conventional hand cart is shown in FIG. 1. By this means the components actually used for lifting the wheels may be very few and simple and they require only a very limited storage space when not in use. Additionally, the hand cart may be used for many other purposes when it is not used together with the lifting device. The eccentric forming the jack further constitutes a very simple, reliable and easily operated means for bringing about the lifting action. The lifting device further requires only a very low number of simple and standardized components and may thus easily be manufactured at a low cost.

The eccentric may be rotationally fixed to the frame and the peripheral support surface may then be arranged to take support on a horizontal bar of the hand cart.

The wheel lifting device may comprise a lever which is fixed to the eccentric for manual manoeuvring of the jack.

The eccentric may comprise a circular disc provided with said peripheral support surface, which disc is rotationally fixed to the frame by means of a spindle which is arranged off-centre the disc.

The eccentric may comprise a non-circular disc provided with a curved peripheral support surface.

The disc may be rotationally fixed to the frame by means of a spindle which is arranged on-centre the disc.

Alternatively, the disc may be rotationally fixed to the frame by means of a spindle which is arranged off-centre the disc.

The difference between the largest radial distance from the peripheral support surface to the rotational axis of the disc and the smallest distance from the peripheral support surface to the rotational axis of the disc may be between 70 and 120 mm.

The guiding means may comprise a first set of guiding plates which are fixed to a front surface of the frame and a second set of guiding plates which are fixed to a rear surface of the frame and at least one set of guiding plates may be removably fixed to the frame.

The wheel support may comprise at least two rods which extend forwardly from a lower portion of the frame.

The rods may be cylindrical and provided with a respective cylindrical hollow sleeve, which sleeves are rotational about the longitudinal axes of the rods.

The frame may be formed of two mutually parallel vertical bars which are connected to each other by means of two mutually parallel horizontal bars.

The eccentric may exhibit an essentially planar end surface which is arranged in frictional contact with the frame.

The wheel lifting device may comprise means for adjusting the frictional force between the eccentric and the frame.

The wheel lifting device may further comprise a two-wheeled tiltable hand cart comprising two vertical bars and a horizontal bar, wherein the frame is arranged rectilinearly displaceable relative to the hand cart along said vertical bars.

The eccentric may be fixed to the hand cart and the peripheral support surface may then be arranged to bear against a horizontal bar of the frame.

The eccentric may exhibit an essentially planar end surface which is arranged in frictional contact with the hand cart.

The hand cart may then comprise a ground support arranged to support the hand cart in an upright position at which position the vertical bars extends in an essentially vertical direction.

Additional objects and advantages of the invention will appear from the following detailed description and from the appended claims.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The terms vertical and horizontal used herein refer to directions of the device when it is in an upstanding position such that the lifting action may be carried out in the vertical direction. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a perspective view illustrating a standardized hand cart together with which the inventive wheel lifting device may be used.

FIG. 2 is a perspective view of the wheel lifting device before it has been mounted to the hand cart shown in FIG. 1.

FIG. 3 illustrates a set of mounting brackets to be used when mounting the wheel lifting device shown in FIG. 2 to the hand cart shown in FIG. 1.

FIG. 4 is a perspective view from the front illustrating the lifting device of FIG. 2 when mounted to the hand cart of FIG. 1.

FIG. 5 is a perspective view from behind of the lifting device and hand cart shown in FIG. 4.

FIG. 6 is a perspective view from the front of the device shown in FIGS. 4 and 5 and further illustrates a wheel to be lifted.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description. Throughout this specification, the terms vertical and horizontal refers to directions of the lifting device and the hand cart when positioned in an upright standing position such as illustrated in the figures.

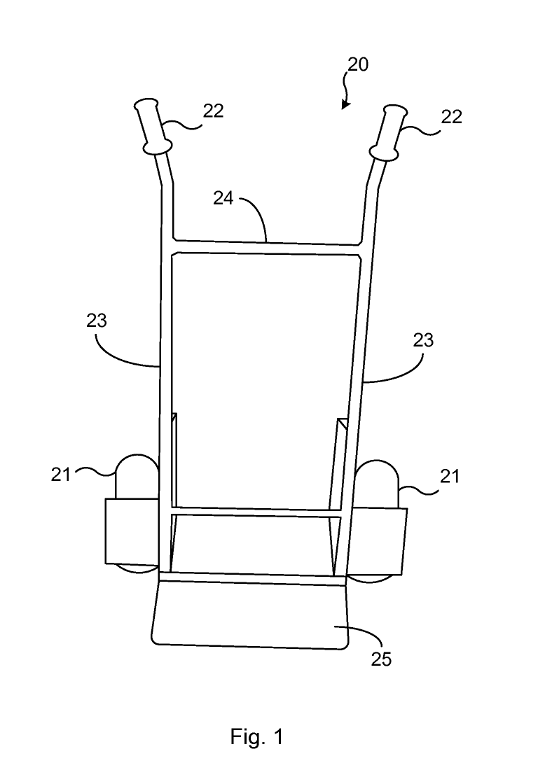

FIG. 1 illustrates a standardized hand cart 20 together with which the wheel lifting device according to the invention may be used. The hand cart 20 is of the tiltable type comprising two wheels 21. The hand cart 20 further comprises two handles 22 for manoeuvring the hand cart. Each handle 21 is fixed to an extension of a respective vertical bar 23. At an upper portion of the vertical bars 23, a horizontal bar 24 extends between the vertical bars 23. The hand cart further comprises a support plate 25. The support plate 25 serves as a supporting structure, which in contact with the ground maintains the hand cart 20 in an upright position. For this purpose, the support plate should preferably be arranged non-pivotal and fixed in relation to the vertical bars. In cases where the support plate is hinged to the vertical bars, there may preferably be provided a locking means (not shown) for fixing the angular position of the support plate in relation to the vertical bars. The support plate 25 also functions as a lower stop for the frame 1 of the lifting device described below.

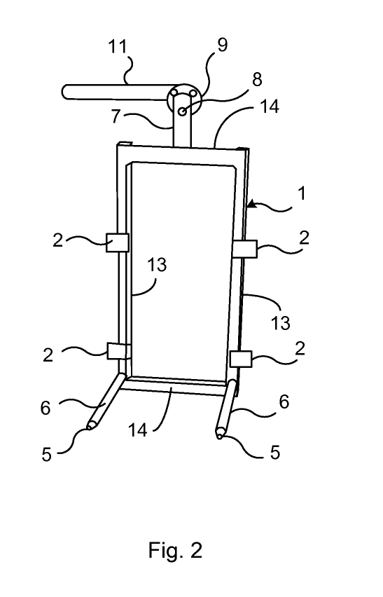

As shown in FIG. 2, the lifting device comprises a frame 1, which may be mounted to the hand cart 20 shown in FIG. 1. The frame comprises two vertical frame bars 13 and two horizontal frame bars 14. The horizontal frame bars 114 extend between the vertical frame bars 13 at a lower and upper end respectively of the frame. In the example shown in the drawings, the frame bars 13, 14 are fixed to each other by means of welding. However, also other fixation means may be used. The frame bars 13, 14 may preferably be of steel, such as DIN 2414. They may be formed of a blank pipe having a hollow circular cross section. However and as described more in detail below, it may be preferable to use a pipe having a square or rectangular hollow cross section. The thickness of material may preferably be 1.2-2.0 mm and the square outer cross sectional dimension between 20-25 mm.

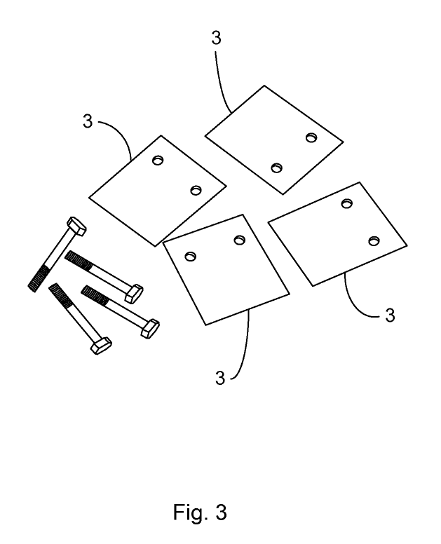

Four first brackets 2 are fixed to a front surface the frame 1. In the exemplifying embodiment shown in the figures the first brackets 2 are welded to the frame. The first brackets 2 may however also be removably fixed thereto, e.g. by means of screws or the like. After the frame 1 has been positioned at the cart 20, four second brackets 3 are fixed to the frame such that the two vertical bars 23 of the cart are received between pairs of first 2 and second 3 brackets. The fixation of the frame 1 by means of the brackets 2, 3 allows the frame 1 to be rectilinearly displaced relative to the cart, along the vertical bars 23. The second brackets 3 are shown separately, before mounting in FIG. 3. The brackets 2, 3 thus form guiding means for the rectilinear displacement of the frame 1 relative to the hand cart 20.

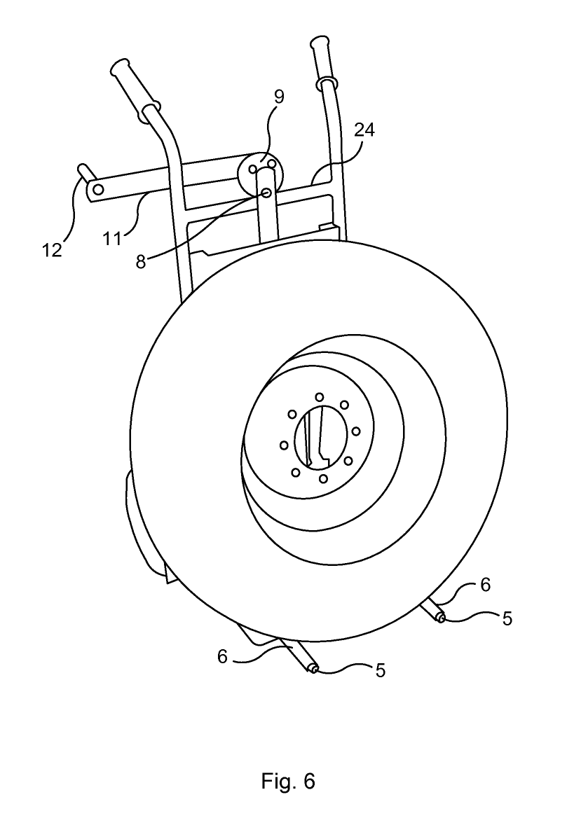

Two wheel supporting rods 5 are fixed to a lower end of the frame 1. The rods 5 thus form a wheel support. In the illustrated example, the rods 5 are cylindrical and extend forwardly from the frame 1, in the horizontal direction, when the cart is in an upright position. The wheel supporting rods may however also have square or similar cross sections. A cylindrical sleeve 6 is threaded onto each rod 5, such that the sleeves 6 may rotate relative to the respective rod 5. When a wheel is positioned on the rods 5 with sleeves 6, the wheel may thereby be rotated about the wheel's normal axis of rotation (see FIG. 6). This facilitates alignment of the lifted wheel's mounting holes with the corresponding holes of the vehicle's hub when attaching the wheel to the hub.

At its upper end, the frame 1 is provided with a vertically oriented support plate 7, which is fixed to the upper horizontal frame bar 14. A shaft or spindle 8 extends generally horizontally, backwards from the support plate 7. A cylindrical cam disc or an eccentric 9 is arranged eccentrically rotational on the spindle 8. In the example shown the eccentric 9 is constituted by a circular disc formed of POM (Delrin). The eccentric may however also be formed of other polymer materials or by metal or any other suitable materials. The eccentric 9 exhibits a peripheral support surface which bears against and is supported by the upper horizontal bar 24 of the hand cart 20. A manoeuvring lever 11 with a handle 12 is fixed to the eccentric 9.

The spindle 9 and eccentric 9 are further arranged such that a first planar end surface of the eccentric 9 is in contact with and pressed against the support plate 7. For this purpose the spindle 8, which extends through the eccentric, comprises a threaded end (not shown) which protrudes backwards, away from a second end surface of the eccentric 9, which second end surface faces away from the support plate 7. A nut (not shown) is threaded onto the threaded end and arranged to press the first planar end surface of the eccentric 9 against the support plate 7. By tightening or loosening the nut it is possible to readily adjust the friction between the eccentric and the support plate. This friction may be used for maintaining the frame 1 and a wheel positioned thereon in a raised position, without the need to manually hold the lever in a corresponding position. By this means the operator may use both hands e.g. when manipulating the wheel and when fastening or loosening the fixation bolts or nuts. Since the friction between the eccentric 9 and the support plate is adjustable, it is possible to vary this friction such that it may sustain the gravitational force of wheels having varying weights. In order to maintain the selected friction for longer periods of time and a repeated use of the wheel lifting device, the nut may preferably be of the type having an elastic insert or top which prevents loosening of the nut relative to the threaded end of the spindle 8.

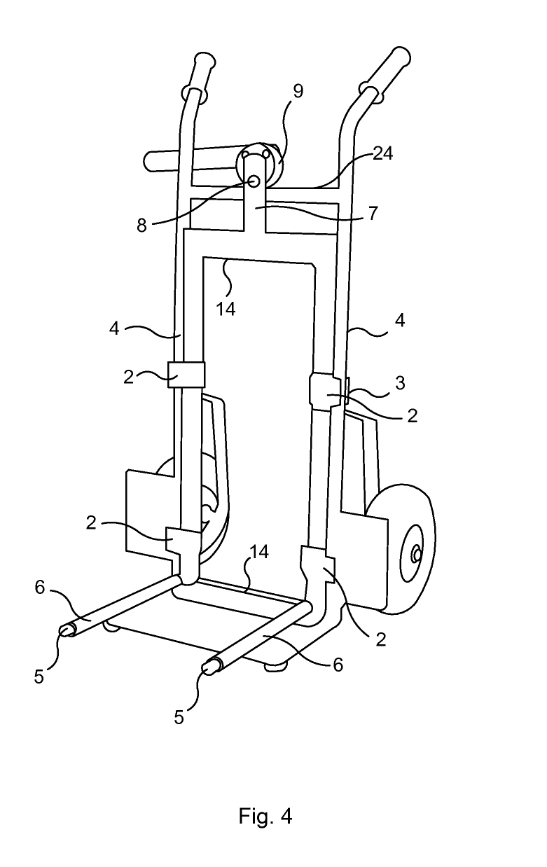

In FIGS. 4-6 the frame 1 is shown in its lowermost position. In this position, the distance between the spindle 8 and the horizontal bar 24 exhibits a minimum. It will be understood that the distance between the spindle 8 and the horizontal bar 24 will increase gradually as the eccentric 9 is rotated in either direction, by means of the lever 11, from the position shown in FIGS. 4-6. By this means it is possible to raise and lower the frame 1 with a wheel resting on the support rods 5 relative to the cart 20, by means of rotating the lever 11. The lifting range is dependent on the diameter of the eccentric 9 and the off centre positioning the spindle 8. In the shown example, the lifting range is chosen to be approx. 80 mm, which is normally sufficient when changing wheels on a car, using a regular car jack for lifting the car and the wheel to be changed above the ground. The desired lifting range may however be varied by choosing the difference between the largest radial distance from the peripheral support surface to the rotational axis of the disc and the smallest distance from the peripheral support surface to the rotational axis of the disc. It has proven to be advantageous if this difference lies between 70 and 120 mm.

In use, the vehicle and a wheel to be shifted may first be lifted by using the vehicle's regular car jack. Typically, the car jack is fitted to the vehicle such that one wheel at the time is raised approx. 30-50 mm above the ground. Thereafter the wheel to be shifted may be loosened and removed manually. The wheel which shall replace the removed wheel is then or before positioned at the wheel supporting rods 5 with sleeves 6 as illustrated in FIG. 6. The hand cart 20 with the wheel lifting device 1 is the manoeuvred using the handles and slightly tilting the hand cart 20 backwards such that the wheel is positioned vertically aligned with the hub (not shown) of the vehicle. It is thereafter possible to raise the wheel by rotating the lever 11 in either direction. By this means the wheel to by mounted may readily and without much power being required, be aligned horizontally with the hub of the vehicle. If the wheel which is to be mounted has the same dimension as the wheel which has been removed, the lever 11 is rotated such that the wheel supporting rods 5 are raised the same distance above the ground as the vehicle was previously lifted, by means of the car jack. However, the comparatively large lifting range or stroke of the wheel lifting device allows for that wheels having comparatively widely varying dimensions may easily be lifted to the correct height for being horizontally aligned with the hub. Once the wheel has been aligned vertically and horizontally, it may easily be aligned rotationally, such that each mounting hole of the wheel is aligned with a corresponding mounting hole or bolt arranged at the hub. This is rotational alignment is facilitated by the fact that the sleeves 6 are able to rotate relative to the wheel supporting rods 5. When the wheel has been so aligned with the hub it is possible to fasten the wheel to the hub by inserting and tightening the fixation bolts or nuts or by any other means applicable to the wheel mounting principle in question. It should be noted that the operator at any instance of the alignment and fastening steps may use both hands for that purpose. This is made possible since it is possible to adjust the friction between the eccentric 9 and the support plate 7, such that this friction may sustain the gravitational force of the wheel for any wheel weight.

Naturally, the wheel lifting device may also be used when removing a wheel already mounded to a vehicle. This may be especially useful when removing heavier wheels as it reduces the risk of back injuries and other disadvantages and risks frequently occurring at manual and muscular handling of heavy and bulky wheels.

The invention has mainly been described above with reference to a few embodiments. However, as is readily appreciated by a person skilled in the art, other embodiments than the ones disclosed above are equally possible within the scope of the invention, as defined by the appended patent claims. For example, at the embodiment described above, the eccentric is formed of a circular cam disc which is eccentrically arranged at a spindle. It is however also possible to form the eccentric as a non circular disc. The non circular disc may be centrically or eccentrically arranged at a spindle or other pivot means. The non circular disc may preferably have a curved peripheral support surface. The peripheral support surface may however, at some applications be provided with facet surfaces such as to provide a stepped rotation of the eccentric.

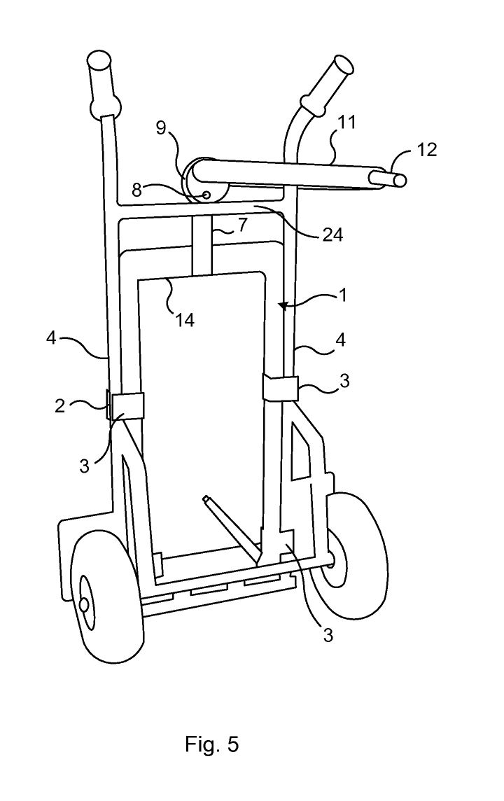

According to another alternative embodiment, which is not illustrated in the figures, the eccentric is rotationally fixed to the hand cart and arranged to lift the frame by means of the peripheral support surface bearing against a portion of the frame. E.g. the eccentric may be rotationally fixed to the hand cart by means of a spindle and a support plate similar to support plate 7 illustrated in FIGS. 4 and 5, but in this case the support plate may instead be fixed to a horizontal bar of the hand cart, such as to a horizontal bar corresponding to bar 24 in FIGS. 4 and 5. The peripheral support surface of the eccentric may then be arranged in bearing contact with a lower surface of a horizontal bar of the frame, e.g. a horizontal bar corresponding to the upper horizontal bar 24 shown in FIGS. 3-5.

Further, the bars forming the hand cart has above been illustrated as having a circular cross section. It is however also possible that these bars exhibit square or rectangular cross sections. The bars may e.g. be formed of square pipes. Such an arrangement may be advantageous since welding together of such square pipes is easier than welding of circular pipes. Additionally, weld joints between square pipes are normally stronger than weld joints between circular pipes. Even further, it has proven that bending of square pipes provides for a stronger bent section, than what is achieved when bending circular pipes.

This is of certain interest since the inventor of the wheel lifting device has realized that the hand cart may be manufactured in a very cost effective manner by utilizing simple bending of square, rectangular or circular metal pipes. Such manufacturing comprises providing a metal pipe of a length corresponding essentially to the twice the height plus the width of the cart to be manufactured. The pipe is then bent a number of times such that it forms a contour corresponding to the handle portions, the vertical bars 23 and the side and front edges of the support plate 25 as seen on the hand cart illustrated in FIG. 1. The so formed hand cart base is then complemented by welding thereto a horizontal bar corresponding to horizontal bar 24 in FIG. 1 and possibly a lower horizontal bar arranged aligned with the wheel axis as indicated in FIG. 1. Thereafter the cart may be finished by attaching two wheels, e.g. by inserting a common wheel axis into the lower horizontal bar or by journal fixation of each wheel separately at a lower portion of the respective vertical bar or at a respective end of the lower horizontal bar. If desired the cart may also be complemented with handles e.g. threaded onto the free ends of the vertical bars, forming handle portions.

By such a method a sturdy and reliable hand cart may be manufactured in a very cost efficient and rapid manner. The components needed may all be standardized components frequently used in the industry and being available at comparatively low costs. The bending operations for forming the hand cart base may further be carried out in a highly automated and fast manner. The formation by bending also replaces several previously used welding or corresponding joining operations, which operations are considerably more time and cost consuming than bending.

The metal pipe provided for forming the cart base by bending may preferably be of steel, such as DIN 2414. A metal pipe having a hollow circular cross section may be used. However and as indicated above, it may be preferable to use a pipe having a square or rectangular hollow cross section. The thickness of material may preferably be 1.2-2.0 mm and the square outer cross sectional dimension between 20-25 mm.

1. A wheel lifting device comprising a frame, a wheel support which is fixed to the frame and a manually manoeuvrable jack, wherein the frame comprises guiding means which are arranged to receive at least two vertical bars of a two-wheeled tiltable hand cart and to guide the frame rectilinearly along said bars during vertical displacement of the frame relative to the handcart, and wherein the jack comprises an eccentric which is rotationally fixed to the frame or arranged to be rotationally fixed to the hand cart and which exhibits a peripheral support surface which is arranged to bear against the hand cart or the frame respectively.

2. The wheel lifting device according to claim 1, wherein the eccentric is rotationally fixed to the frame and the peripheral support surface is arranged to take support on a horizontal bar of the hand cart.

3. The wheel lifting device according to any of claims claim 1, comprising a lever which is fixed to the eccentric for manual manoeuvring of the jack.

4. The wheel lifting device according to claim 1, wherein the eccentric comprises a circular disc provided with said peripheral support surface, which disc is rotationally fixed to the frame by means of a spindle which is arranged off-centre the disc.

5. The wheel lifting device according to claim 1, wherein the eccentric comprises a non-circular disc provided with a curved peripheral support surface.

6. The wheel lifting device according to claim 5, wherein the disc is rotationally fixed to the frame by means of a spindle which is arranged on-centre the disc.

7. The wheel lifting device according to claim 5, wherein the disc is rotationally fixed to the frame by means of a spindle which is arranged off-centre the disc.

8. The wheel lifting device according to claim 1, wherein the difference between the largest radial distance from the peripheral support surface to the rotational axis of the disc and the smallest distance from the peripheral support surface to the rotational axis of the disc is between 70 and 120 mm.

9. The wheel lifting device according to claim 1, wherein the guiding means comprises a first set of guiding plates which are fixed to a front surface of the frame and a second set of guiding plates which are fixed to a rear surface of the frame and wherein at least one set of guiding plates are removably fixed to the frame.

10. The wheel lifting device according to claim 1, wherein the wheel support comprises at least two rods which extend forwardly from a lower portion of the frame.

11. The wheel lifting device according to claim 10, wherein the rods are cylindrical and provided with a respective cylindrical hollow sleeve, which sleeves are rotational about the longitudinal axes of the rods.

12. The wheel lifting device according to claim 1, wherein the frame is formed of two mutually parallel vertical frame bars which are connected to each other by means of two mutually parallel horizontal frame bars.

13. The wheel lifting device according to claim 1, wherein the eccentric exhibits an essentially planar end surface which is arranged in frictional contact with the frame.

14. The wheel lifting device according to claim 13, comprising means for adjusting the frictional force between the eccentric and the frame.

15. The wheel lifting device according to claim 1, further comprising a two-wheeled tiltable hand cart comprising two vertical bars and a horizontal bar, wherein the frame is arranged rectilinearly displaceable relative to the hand cart along said vertical bars.

16. The wheel lifting device according to claim 15, wherein the eccentric is fixed to the hand cart and the peripheral support surface is arranged to bear against a horizontal bar of the frame.

17. The wheel lifting device according to claim 16, wherein the eccentric exhibits an essentially planar end surface which is arranged in frictional contact with the hand cart.

18. The wheel lifting device according to claim 15, wherein the hand cart comprises a ground support arranged to support the hand cart in an upright position at which position the vertical bars extends in an essentially vertical direction.

19. The wheel lifting device according to claim 16, wherein the hand cart comprises a ground support arranged to support the hand cart in an upright position at which position the vertical bars extends in an essentially vertical direction.

20. The wheel lifting device according to claim 17, wherein the hand cart comprises a ground support arranged to support the hand cart in an upright position at which position the vertical bars extends in an essentially vertical direction.
